(19) United States
(12) Patent Application Publication
(10) Pub. No.: US 2011/0253281 A1
(43) Pub. Date: Oct. 20, 2011

(54) Tire With A Belt Having Offset Cables

(75) Inventor: Damon L. Christenbury, Fountain Inn, SC (US)

(73) Assignee: Michelin Recherche et Technique SA and Societe de Technologie Michelin

(21) Appl. No.: 12/760,898

(22) Filed: Apr. 15, 2010

(51) Int. Cl. B60C 9/04

(52) U.S. Cl. 152/538

(57) ABSTRACT

This invention relates generally to an improved tire design that has at least one belt with cables that are offset from each other, and, more specifically, to a tire that has at least two belts that each have cables that are offset from each other, thereby reducing the amount of shear that exists near the free edge of the belts and the likelihood of belt separation when the tire rotates at high speed. This design is effective when the ratio of the radius, Rₛ, which is defined as the radial distance from the axis of rotation of the tire to a free edge of a cable of a belt of the tire, to the radius, R_{c}, which is defined as the radial distance from the axis of rotation of the tire to a topmost or crown portion of the belts, is greater than 0.95.

### BACKGROUND OF THE INVENTION

1. Field of the Invention

This invention relates generally to an improved tire design that has at least one belt with cables that are offset from each other, and, more specifically, to a tire that has at least two belts that each have cables that are offset from each other, thereby reducing the amount of shear that exists near the free edge of the belts and the likelihood of belt separation when the tire rotates at normal operating conditions. This design is effective when the ratio of the radius, Rₛ, which is defined as the radial distance from the axis of rotation of the tire to a free edge of a cable of a belt of the tire, to the radius, R_{c}, which is defined as the radial distance from the axis of rotation of the tire to a topmost or crown portion of the belts, is greater than 0.95.

2. Description of the Related Art

Those skilled in the art of pneumatic tires have developed a wealth of experience in trying to improve the high speed endurance of tires. One problem that is commonly encountered when tires is belt separation. The mechanism that leads to this belt separation includes centrifugation, which is the natural tendency for the belts to grow in the radial direction of the tire as the tire rotates with ever increasing speeds, and belt edge shear which occurs at the free edges of the cables of the belts as the tire rolls through the contact patch. In either case, the stress and strain in this area leads to the belts shearing relative to each other. This in turn causes the belts to start to separate from each other near their free edges. This separation then grows until centrifugation and cycling causes the belts to separate from each other.

Several methods have been used previously to address belt separation. One solution has been to reduce the angle that cables form with the circumferential direction of the tire, which reduces the strain in this area. However, this has the drawback that the comfort of the tire is adversely affected. Consequently, another solution as been to alter the angle at which the cables of a belt are posed at so that they form a larger angle with the circumferential direction of the tire in the middle of the belt and a lesser angle near the shoulders of the belts. Thus, a tire with belts having a lower aptitude for belt separation while still providing the desired comfort and handling can be provided. This has disadvantages such as the cost of special machinery needed to lay the individual cables at the various angles as compared to more conventional techniques for placing cables in the belts, which include co-extruding the cables with a rubber skim in a very economical fashion.

Yet another solution to this problem is presented by Japanese Patent Application Publication No. JP61037501. As shown by the figures and specification of that reference, and part of which is reproduced herein as FIG. 1 for the convenience of the reader, using belts that have cables that are offset from each other such that one end of one cable 100 is spaced away from the free end 102 of the belt 104 by a distance, O, along the length of the cables reduces the amount of shear that is present near the free edge of a tire belt. Unfortunately, this reference teaches that this improvement is only effective for tires that have very rounded tread regions such as is commonly used in specialty tires including tires used in aircraft, agricultural and construction environments.

This criteria is represented by one of the figures of that reference, and is reproduced herein as FIG. 2. Put into numerical terms based on the dimensions shown in FIG. 2, this reference says that belts with offset cables are effective in tires when the ratio of the radius, Rₛ, which is defined as the radial distance from the axis of rotation 106 of the tire 108 to a free edge 110 of a cable 100 of a belt 104 of the tire 108, to the radius, R_{c}, which is defined as the radial distance from the axis of rotation 106 of the tire 108 to a topmost 112 or crown portion of the belts, is greater than 0.95. Since most tires, such as passenger car, light truck and heavy truck tires, use constructions that have considerably flatter treads where the ratio of Rₛ/R_{c} is greater than 0.95, this solution according to this reference does not solve the problem for the bulk of tire applications. Accordingly, a solution that will work with tires with flat tread constructions where the ratio of Rₛ/R_{c} is greater than 0.95 is needed.

Furthermore, some newer tire construction methods differ from more conventional tire construction methods which typically involve the use of prefabricated belts that are made by first co-extruding cables within a rubber skim and then cutting these products at an angle to a form a belt with the desired width and cables that are posed at a desired angle. Instead, these newer construction methods build tires component by component so that belts are not prefabricated items that are placed into a tire but are built up by using discrete components. For instance, the belts may be created by laying down the rubber separately from the cables which are individually laid down. Often with such tire building techniques, the length of cable that is available for building belts is limited to a few specified lengths in order to reduce the inventory of cables and to standardize tire fabrication as much as possible. In some cases, only a single length of cable is available. Of course, this presents the challenge of building belts with different widths and with cables that are posed at different angles. Therefore, there is a need to be able to create belts having different widths and/or cables posed at different angles using cables having a fixed length.

For all reasons set forth above, there is a need for a new belt construction that reduces belt edge shear for tires that have flat tread sections as is typically used in passenger car, light truck and heavy truck tire applications. In particular, it would be beneficial if this new belt construction worked with tires having flat tread constructions where the ratio of Rₛ/R_{c} is greater than 0.95. It would be even more advantageous if this belt construction could be made using new tire construction methods that require all the cables used in the belts of tires be of the same length.

### SUMMARY OF THE INVENTION

Particular embodiments of the present invention include a tire with a ground contacting portion and having radial, longitudinal, axial directions, an axis of rotation and an equatorial plane. The tire also has a first belt below its ground contacting portion that has first and second free edges along the axial extents of said belt. This first belt includes at least one cable that has a first end that extends substantially to one of said free edges and a second cable that is offset from said first cable such that the second cable does not extend to said first free edge of said belt. The tire is further characterized in that the ratio of Rₛ/R_{c} is greater than 0.95, where Rₛ is the radial distance from said first end of the first cable to the axis of rotation of the tire and R_{c} is the radial distance from the crown or topmost portion of said first cable to the axis of rotation of the tire.

In some cases, the first cable has a second end that extends substantially to the second free edge of said first belt and said second cable has a second end that is offset from the second end of the first cable such that the second cable does not extend to either free edge of said belt.

In such a case, the distance the first end of the second cable is offset from the first end of the first cable may be equal to the distance the second end of the second cable is offset from the second end of the first cable.

Furthermore, the tire may comprise a second belt with free edges at its axial extents and that includes at least one cable that has a first end that extends substantially to one of the free edges of the second belt. This belt may also have a second cable that has a first end that is offset from said first cable of the second belt such that the second cable does not extend to the first free edge of said second belt. This second belt may be found radially above the first belt.

In other cases, the width of the first belt may be in the range of 150 to 320 millimeters. Sometimes, the first cable and the second cable are parallel to each other. When they are parallel to each other, the first and second cable may form angles with the equatorial plane of the tire, which are in the range of 18 to 37 degrees.

Sometimes, the distance the first end of the first cable is offset from the second end of the second cable is in the range of 1 to 70 millimeters.

In other embodiments, the first belt further comprises a third cable that extends substantially to both free edges of the first belt and that is adjacent the second cable of the first belt. This first belt may further comprise a fourth cable that is adjacent to the third cable and that has a substantially identical configuration to the second cable of the first belt and that is aligned axially with the second cable of the first belt.

Sometimes in a belt according to the present invention, the pitch from the first cable to the second cable in a direction substantially perpendicular to the cables in the offset region of the belt, which may be the shoulder region of the belt, ranges approximately from 1.8 mm to 7.0 mm and ranges from approximately 0.9 mm to 3.5 mm in another region of the belt, which may be the center region of the belt.

In yet other situations, the first and second cables are substantially parallel to each other.

The diameter of the first cable may be substantially the same as the diameter of the second cable and may fall within the range of 0.5 to 1.5 millimeters.

The length of either the first or second cable may be 500 millimeters.

In some applications, the tire is a 265/75R16 sized tire. The foregoing and other objects, features and advantages of the invention will be apparent from the following more detailed descriptions of particular embodiments of the invention, as illustrated in the accompanying drawing wherein like reference numbers represent like parts of the invention.

### BRIEF DESCRIPTION OF THE DRAWINGS

FIG. 1 depicts a belt with offset cables used in a prior art tire disclosed by Japanese Patent Application Publication No. JP61037501.

FIG. 2 shows the dimensions, Rₛ and R_{c}, of the prior art tire in which the belt of FIG. 1 was used.

FIG. 3 depicts a typical lamina or belt including its typical properties and components.

FIG. 4 is a graph that shows the Lamina or belt modulus versus the belt cable angle as predicted by both analytical and FEA techniques, indicating that there is a good correlation between both techniques.

FIG. 5 illustrates the dimensions, components and properties of a typical belt package including a first belt 104 and second belt 104′ with cords posed at equal and opposite angles that are separated by a thin rubber layer 116.

FIG. 6 is a graph showing Laminate centerline modulus for a belt package versus the belt cable angle as predicted by both analytical and FEA techniques, indicating that there is a good correlation between both techniques except when the cable angle α is less than 15 degrees due to the infinite cable modulus assumption made for the analytical case.

FIG. 7 is a representation of the interply shear strain.

FIG. 8 is a graph that shows the interply shear strain versus belt width as predicted by the analytical and FEA models, showing that there is a good correlation between both techniques.

FIG. 9 is an enlarged view of the internal construction of a discrete finite element model of a two-ply cable reinforced laminate, which represents the typical belt package of a tire.

FIG. 10 is an enlarged view of the discrete model boundary conditions applied in the FEA model.

FIG. 11 contains top and side views of the locations, A and B, at the midplane of the rubber layer where the interply shear strain will be evaluated as a function of lateral position.

FIG. 12 is a graph showing a comparison of discrete model and homogeneous theory interply shear strain values for the nominal case where the cable diameter is 0.56 mm, cable pace is 1.6 mm, rubber layer thickness is 0.9 mm and belt angle is 25°. The centerline axial strain is prescribed at 0.1% (edge strain is therefore 0.08%).

FIG. 13 is a graph showing a comparison of corrected discrete model and homogeneous theory interply shear strain values for the nominal case where the cable diameter is 0.56 mm, cable pace is 1.6 mm, rubber layer thickness is 0.9 mm and belt angle is 25°. The centerline axial strain is prescribed at 0.1%.

FIG. 14 contains graphs depicting the interply shear strain variation at the ply edge between cables and along the midplane.

FIG. 15 shows a modified version of FEA model for the belt package of FIG. 9 having cables that are offset.

FIG. 16 depicts the boundary conditions applied to the FEA model of FIG. 15.

FIG. 17 is a full tire FEA model that is compatible with the belt package FEA model of FIG. 15.

FIG. 18 is a graph that shows the reduction in shear strain for a belt having offset cables as compared to a narrower belt or to a belt having the same width but having no offset cables.

FIG. 19 is a graph illustrating the change of angle possible to achieve using a cable of fixed length that is placed in a belt using an offset.

FIG. 20 shows the possible belt angles α that are achievable for belts having different widths by using different offset values and a fixed cable length of 500 mm.

### DETAILED DESCRIPTION OF PARTICULAR EMBODIMENTS

Reference will now be made in detail to embodiments of the invention, one or more examples of which are illustrated in the Figures. Each example is provided by way of explanation of the invention, and not meant as a limitation of the invention. For example, features illustrated or described as part of one embodiment can be used with another embodiment to yield still a third embodiment. It is intended that the present invention include these and other modifications and variations. It should be noted that for the purposes of discussion, only a portion of the exemplary tire embodiments may be depicted in one or more of the figures. Reference numbers are used in the Figures solely to aid the reader in identifying the various elements and are not intended to introduce any limiting distinctions among the embodiments. Common or similar numbering for one embodiment indicates a similar element in the other embodiments. One of ordinary skill in the art, using the teachings disclosed herein, will understand that the tire incorporates one of more features that are commonly used in tires even if they are not specifically shown.

In order to develop an accurate way to model the belts with offset cables and the shear that occurs between them, analytical models were chosen from those that were known in the literature to be fairly accurate and techniques for creating an accurate FEA model that were also known in the literature were adopted. Such a FEA model is described in a paper entitled, “Analytical Solution for the Stresses Arising in +/−Angle Ply Belts of Radial Tires”, authored by Robert D. McGinty, Steven M. Cron and Timothy B. Rhyne. Portions of that paper are reproduced herein under the “Development of FEA Model” section of this application, which immediately follows. Then, the present invention is discussed in the “Detailed Description of FEA Study on Belt Package with Belts having Offset Cables” section of the application.

### Development of FEA Model

### Derivation of the Lamina Equations

FIG. 3 gives a schematic representation of the lamina, which is essentially a tire belt 104 with cables 100 embedded in a rubber skim 114. The material or local coordinates are labeled 1, 2, 3 where the cable follows the “1” direction. The body or global coordinates are labeled X, Y, Z where the “X” direction represents the circumferential direction in the tire and primary loading direction, “Y” represents the width direction of the belts or axial direction of the tire, and “Z” represents the thickness direction of the belts, the radial direction in the tire. The lamina can be described by six parameters: E_{c}, the cable modulus, P, the cable pace, α, the angle of the cable relative to the X body coordinate, D, the cable diameter and assumed lamina thickness, E, the modulus of the rubber, and ν, Poison's ratio of the rubber.

The derivation of the lamina equations is well known and will not be carried out in detail here. The equations can be found in composite materials texts such as Jones [5]. The strain transformation equations between the local lamina and global coordinates can be written as

$${ɛ}_{x} = {ɛ}_{1} {cos}^{2} α + ( \frac{P - D}{P} ) [ {ɛ}_{2} {sin}^{2} α - {γ}_{12}^{2} cos α sin α ] \\ {ɛ}_{y} = {ɛ}_{1} {sin}^{2} α + ( \frac{P - D}{P} ) [ {ɛ}_{2} {cos}^{2} α + {γ}_{12}^{2} cos α sin α ] \\ {γ}_{xy} = {ɛ}_{1} sin 2 α + ( \frac{P - D}{P} ) [ - {ɛ}_{2} sin 2 α + {γ}_{12} cos 2 α ] . \qquad ( 1 )$$

Note that these equations are the same as the two dimensional orthotropic strain transformation equations, Jones Eq 2.68 for example, except for the addition of the

$$( \frac{P - D}{P} )$$

factor. The strains ε₂ and γ₁₂ apply to the rubber only since we assumed that the cable does not strain in these directions. These strains are thus scaled by the

$$( \frac{P - D}{P} )$$

factor to give the correct average response of the composite lamina.

The strain stress equations for the lamina can be written as

$${ɛ}_{x} = \frac{{cos}^{2} α}{{V}_{c} {E}_{c}} [ {σ}_{x} {cos}^{2} α + {σ}_{y} {sin}^{2} α + 2 {τ}_{xy} sin αcos α ] + \frac{1 + υ}{E} ( \frac{P - D}{P} ) \{ \begin{matrix}{σ}_{x} {sin}^{2} α [ 2 - ( 1 + υ ) {sin}^{2} α ] - \\ {σ}_{y } ( 1 + υ ) {cos}^{2} α {sin}^{2} α - {τ}_{xy} sin 2 α [ 1 - ( 1 + υ ) {sin}^{2} α ]\end{matrix} \} \\ {ɛ}_{y} = \frac{{sin}^{2} α}{{V}_{c} {E}_{c}} [ {σ}_{x} {sin}^{2} α + {σ}_{y} {cos}^{2} α - 2 {τ}_{xy} sin αcos α ] + \frac{1 + υ}{E} ( \frac{P - D}{P} ) \{ \begin{matrix}{σ}_{y} {cos}^{2} α [ 2 - ( 1 + υ ) {cos}^{2} α ] - \\ {σ}_{x } ( 1 + υ ) {cos}^{2} α {sin}^{2} α - {τ}_{xy} sin 2 α [ 1 - ( 1 + υ ) {cos}^{2} α ]\end{matrix} \} \qquad ( 2 )$$

These equations can be obtained from Jones Eq 2.82 for example. The quantity, V_{c}, is the volume fraction of the cable. Note that the first term in each of these equations represents the cable contribution to the strain and the second term represents the rubber contribution. At this point it would be interesting to compare these results with a FE analysis of a lamina. Using the first of Eqs 2 we can compute the longitudinal modulus of a lamina, E_{LAMINA}, by dividing the longitudinal stress by the longitudinal strain while letting the lateral stress, σ_{y}, and shear stress, τ_{xy}, be zero. The result is

$$\frac{{σ}_{x}}{{ɛ}_{x}} = {E}_{LAMINA} = \frac{1}{\frac{{cos}^{4} α}{{V}_{c} {E}_{c}} + \frac{1 + υ}{E} [ \frac{P - D}{P} ] [ 2 - ( 1 + υ ) {sin}^{2} α ] {sin}^{2} α} . \qquad ( 3 )$$

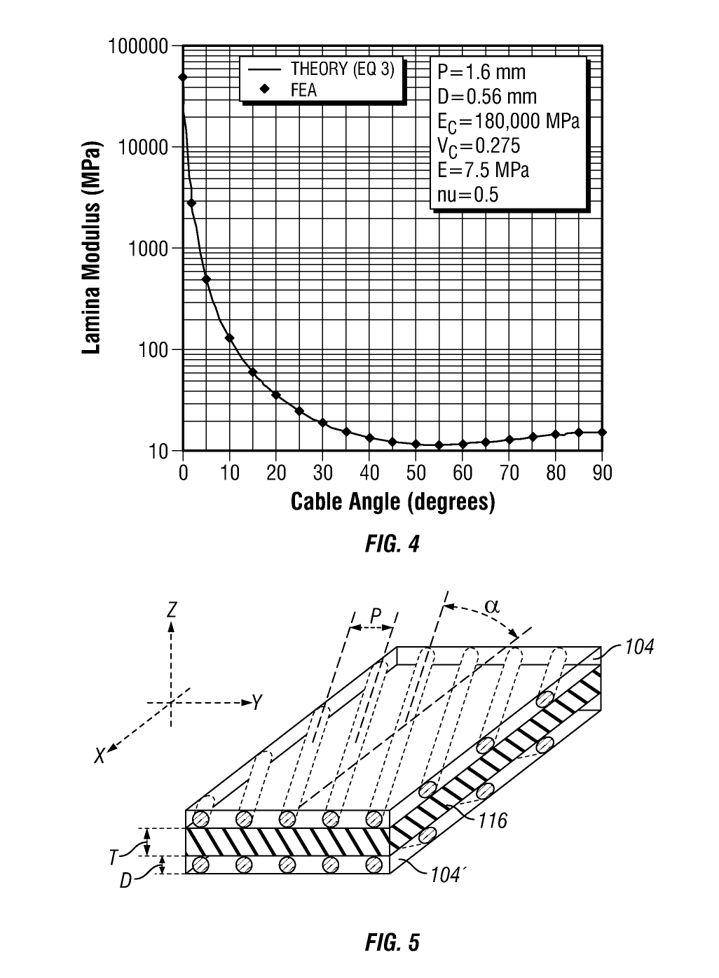

The FEA simulation is made with a two dimensional axisymmetric cylinder of a large radius made up of a single element in ABAQUS. The loading is an imposed increase in the cylinder radius, which results in an imposed elongation in the circumferential direction. The rubber part is defined as a hyperelastic incompressible material described by Treloar's law. The steel is given a linear elastic, homogeneous, orthotropic material definition. The cable angle is varied from zero to 90 degrees. The FEA model compared with the analytical solution, Eq 3, is given in FIG. 4 along with the details of the model. A base set of belt parameters commonly found in radial tires is used and will be used for further calculations. The agreement is very good which gives confidence to continue to a model of the laminate belts.

### Biased Belt Composite

Now we will construct a composite made up of two laminas or belts 104, 104′ as described above having +/−cable angles and separated by a homogeneous isotropic rubber layer 116. This laminate will represent the belt package found in modern radial tires. The laminate is shown in FIG. 5. One additional parameter is introduced, the rubber layer thickness, T. For a given elongation, εₓ, the resulting stress, σₓ, in the first belt is much greater if the second belt is present than if the first belt is alone. Yet Eq. 2 must still apply to each belt whether the other is present or not. Each belt transmits its presence to the other through stresses generated in the rubber layer. Typically the assumption is made that only the shear stresses in the rubber layer are significant. The shear stresses are certainly important but the lateral stress in the rubber layer is also of first order. We will first begin with the shear stress.

### In Plane Shear Stress, τ_{xy}

The stress equilibrium equation in the x direction is

$$\frac{\partial {σ}_{x}}{\partial x} + \frac{\partial {τ}_{xy}}{\partial y} + \frac{\partial {τ}_{xz}}{\partial z} = 0. \qquad ( 4 )$$

For uniaxial elongation the derivative

$$\frac{\partial {σ}_{x}}{\partial x} = 0.$$

Then Eq 4 becomes

$$\frac{\partial {τ}_{xy}}{\partial y} = - \frac{\partial {τ}_{xz}}{\partial z} . \qquad ( 5 )$$

For the second belt, the derivative on the right side of Eq 5 can be written as

$$\frac{\partial {τ}_{xz}}{\partial z} = \frac{{τ}_{xz , belt 2 top} - {τ}_{xz , belt 2 bottom}}{D} . \qquad ( 6 )$$

But the shear stress on top of belt two is zero since it is a free surface. Therefore we can write, using Eq 5 and 6

$$\frac{\partial {τ}_{xy}}{\partial y} = \frac{{τ}_{xz , belt 2 bottom}}{D} . \qquad ( 7 )$$

The shear stress at the bottom of belt two equals the shear stress in the rubber layer which is

τ_{xz,rubber layer}=Gγ_{xz,rubber layer}. (8)

Inserting Eq 8 into Eq 7 gives

$$\frac{\partial {τ}_{xy}}{\partial y} = G \frac{{γ}_{xz , rubber layer}}{D} . \qquad ( 9 )$$

But the shear strain in the rubber layer is related to the x-direction displacements of belt one and belt two such that

$${γ}_{xz , rubber layer} = \frac{{u}_{belt 2} - {u}_{belt 1}}{t} . \qquad ( 10 )$$

For the plus and minus angled composite

u_{belt2}=u_{belt1}. (11)

Using Eq 11, Eq 10 becomes

$${γ}_{xz , rubber layer} = 2 \frac{{u}_{belt 2}}{t} . \qquad ( 12 )$$

Insert Eq 12 into Eq 9 giving

$$\frac{\partial {τ}_{xy}}{\partial y} = \frac{2 G}{tD} {u}_{belt 2} . \qquad ( 13 )$$

Recognize that

$${u}_{belt 2} = {\int }_{0}^{y} \frac{\partial u}{\partial y} d y . \qquad ( 14 )$$

Insert Eq 14 into Eq 13 and differentiate to obtain

$$\frac{{\partial }^{2} {τ}_{xy}}{\partial {y}^{2}} = \frac{2 G}{tD} \frac{\partial u}{\partial y} . \qquad ( 15 )$$

This equation relates the in-plane shear stress in the composite to its x-direction displacement. Recall the small strain definitions and the fact that in our problem

$$\frac{\partial u}{\partial x} = 0 , then {γ}_{xy} = \frac{\partial u}{\partial y} .$$

Thus Eq 15 becomes

$$\frac{{\partial }^{2} {τ}_{xy}}{\partial {y}^{2}} = \frac{2 G}{tD} {γ}_{xy} . \qquad ( 16 )$$

Note that Eqs 12 and 13 could be combined to give

$${γ}_{xz , rubber layer} = \frac{D}{G} \frac{\partial {τ}_{xy}}{\partial y} . \qquad ( 17 )$$

This turns out to be a convenient form to use later in the calculation of the interply shear strain.

### Lateral Stress, σ_{y}

To this point the derivation is straightforward and does not add significantly to the existing literature. It has incorporated the effects of intraply stresses as well as interply shear stresses. The classical solution of Puppo and Evansen [1] also includes all these aspects, but neglects the effects of lateral stresses in the rubber layer. It will now be shown that this assumption is un-necessary and reduces the accuracy of the results. The lateral stresses in the belt composite come from two sources.

The first is simply an imposed stress from an external source. We will name this stress σ_{y,BE}, for “y-stress imposed at the belt edge”.

The second source of lateral stress is generated internally from the fact that the rubber layer is sandwiched between the two orthotropic belt laminas. Consider that a belt composite is stretched to εₓ=1%. Since the rubber in the rubber layer is incompressible, (ν=0.5), it will, without interference from the belt layers, become narrower such that ε_{y}=0.5%. The belt lamina acting alone under the same extension will become much more narrow than that at the relatively small cable angles used in tires, |ε₃>>0.5%. The rubber layer, constrained above and below by the belt layers, will therefore be put in compression. This compression will be reacted by tension in the belt layers such that the net internal force is zero. Recall Hooke's law for the plane stress lateral strain in isotropic materials.

$${ɛ}_{y} = \frac{1}{E} ( {σ}_{y} - v {σ}_{x} ) .$$

Invert this equation to express stress in terms of strain

$${σ}_{y} = \frac{E}{1 - {υ}^{2}} ( {ɛ}_{y} + v {ɛ}_{x} ) . \qquad ( 18 )$$

Next write the equilibrium of the internal lateral forces in the belts

(2 Belts)(σ_{y,belt})(D)+(σ_{y,rubber layer})(t)=0.

Solve this expression for the belt lateral stress

$${σ}_{y , belt} = - \frac{1}{2} ( \frac{t}{D} ) {σ}_{y , rubber layer} . \qquad ( 19 )$$

Note that the strains, εₓ and ε_{y}, of the belts and rubber layer must all be the same, since they are one laminate. The σ_{y,rubber layer} is given by Eq 18 and is substituted into Eq 19 to give the lateral stress in each belt

$${σ}_{y} = {σ}_{y , BE} - \frac{E}{2 ( 1 - {υ}^{2} )} ( \frac{t}{D} ) ( {ɛ}_{y} + υ {ɛ}_{x} ) . \qquad ( 20 )$$

Apply inextensibility to the cables ε₁=0, E_{c}→∞

While the lamina equations derived above contain a finite cable modulus, we will now enforce the assumption that the cable modulus, E_{c}, is infinite and thus the strain in the cable direction is zero in order to make the laminate equations tractable. Thus, the first terms of Eq. 1 and Eq. 2 are eliminated. The strain transformation equations, Eq 1, become

$${ɛ}_{x} = ( \frac{P - D}{P} ) [ {ɛ}_{2} {sin}^{2} α - {γ}_{12}^{2} cos α sin α ]$$

$${ɛ}_{y} = ( \frac{P - D}{P} ) [ {ɛ}_{2} {cos}^{2} α + {γ}_{12}^{2} cos α sin α ]$$

$${γ}_{xy} = ( \frac{P - D}{P} ) [ {γ}_{12} cos 2 α - {ɛ}_{2} sin 2 α ] .$$

Combine these equations to eliminate ε₂ and γ₁₂ resulting in

εₓ cos^{2 α+ε}_{y} sin² α+γ_{xy} sin α cos α=0. (21)

Now let the cable modulus, E_{c}, go to infinity in Eq 2 leaving only the rubber component of the strain

$${ɛ}_{x} = \frac{1 + υ}{E} ( \frac{P - D}{P} ) \{ \begin{matrix}{σ}_{x} {sin}^{2} α [ 2 - ( 1 + υ ) {sin}^{2} α ] - {σ}_{y} ( 1 + υ ) {cos}^{2} α {sin}^{2} α - \\ {τ}_{xy} sin 2 α [ 1 - ( 1 + υ ) {sin}^{2} α ]\end{matrix} \} \\ {ɛ}_{y} = \frac{1 + υ}{E} ( \frac{P - D}{P} ) \{ \begin{matrix}{σ}_{y} {cos}^{2} α [ 2 - ( 1 + υ ) {cos}^{2} α ] - {σ}_{x} ( 1 + υ ) {cos}^{2} α {sin}^{2} α - \\ {τ}_{xy} sin 2 α [ 1 - ( 1 + υ ) {cos}^{2} α ]\end{matrix} \} \\ {γ}_{xy} = \frac{1 + υ}{E} ( \frac{P - D}{P} ) \{ \begin{matrix}- {σ}_{y} sin 2 α [ 1 - ( 1 + υ ) {cos}^{2} α ] - {σ}_{x} sin 2 α [ 1 - ( 1 + υ ) {sin}^{2} α ] + \\ {τ}_{xy} [ 2 - ( 1 + υ ) {sin}^{2} 2 α ]\end{matrix} \} \qquad ( 22 )$$

Eqs 22 can be expressed in matrix form as

$$[ \begin{matrix}{ɛ}_{x} \\ {ɛ}_{y} \\ {γ}_{xy}\end{matrix} ] = [ \begin{matrix}{A}_{11} & {A}_{12} & {A}_{13} \\ {A}_{21} & {A}_{22} & {A}_{23} \\ {A}_{31} & {A}_{32} & {A}_{33}\end{matrix} ] [ \begin{matrix}{σ}_{x} \\ {σ}_{y} \\ {τ}_{xy}\end{matrix} ] . \qquad ( 23 )$$

Note that the Aᵢⱼ matrix is symmetric.

### Simultaneous Equations

Using the results to this point we can write a system of equations that describe the deformations of +/−angle ply composite belts,

$$[ \begin{matrix}{ɛ}_{x} \\ {ɛ}_{y} \\ {γ}_{xy}\end{matrix} ] = [ \begin{matrix}{A}_{11} & {A}_{12} & {A}_{13} \\ {A}_{21} & {A}_{22} & {A}_{23} \\ {A}_{31} & {A}_{32} & {A}_{33}\end{matrix} ] [ \begin{matrix}{σ}_{x} \\ {σ}_{y} \\ {τ}_{xy}\end{matrix} ] \qquad ( 23 )$$

where the coefficients are given by Eq 22, and

$$\begin{matrix}{ɛ}_{x} {cos}^{2} α + {ɛ}_{y} {sin}^{2} α + {γ}_{xy} sin α cos α = 0 & ( 21 ) \\ \frac{{\partial }^{2} {τ}_{xy}}{\partial {y}^{2}} = \frac{2 G}{tD} {γ}_{xy} & ( 16 ) \\ {σ}_{y} = {σ}_{y , BE} - \frac{E}{2 ( 1 - {υ}^{2} )} ( \frac{t}{D} ) ( {ɛ}_{y} + υ {ɛ}_{x} ) . & ( 20 )\end{matrix}$$

We thus have six equations for the six dependent variables

σₓ,σ_{y},τ_{xy},εₓ,ε_{y},γ_{xy}.

Note that the only differential equation is Eq 16.

The equations will be solved assuming a known constant extensional strain, εₓ, and a known imposed lateral stress at the belt edge σ_{y,BE} if any. Using this set of equations eliminate γ_{xy} from Eq. 16 giving

$$\frac{{\partial }^{2} {τ}_{xy}}{\partial {y}^{2}} ( \frac{tD}{2 G} ) [ {A}_{11} + ( {A}_{12} {A}_{31} - {A}_{11} {A}_{32} ) ( \frac{t}{D} ) \frac{E}{2 ( 1 - {υ}^{2} )} \frac{1}{{tan}^{2} α} ] - ( {A}_{11} {A}_{33} - {A}_{13} {A}_{31} ) {τ}_{xy} = ( {A}_{11} {A}_{32} - {A}_{12} {A}_{31} ) {σ}_{y , BE} + {ɛ}_{x} [ {A}_{31} - ( {A}_{12} {A}_{31} - {A}_{11} {A}_{32} ) \frac{E}{2 ( 1 - {υ}^{2} )} ( \frac{t}{D} ) ( \frac{1}{{tan}^{2} α} - υ ) ] . \qquad ( 24 )$$

Eq 24 is a second order differential equation for τ_{xy}. The solution has the form,

τ_{xy}=Ae^{sy}+Be^{-sy}+C

The boundary conditions are:
1.

$$\frac{\partial {τ}_{xy}}{\partial y} = 0 at y = 0 ,$$

the belt composite centerline
2. τ_{xy}=0 at y=w, the edge of the belts.

The solution of Eq 24 can then be written as

$$\begin{matrix}{τ}_{xy} = \{ \frac{{σ}_{y , BE}}{tan α} + {ɛ}_{x} \frac{E}{( 1 - {υ}^{2} )} [ \frac{P}{P - D} + \frac{1}{2} ( \frac{t}{D} ) ] \frac{1}{tan α} ( \frac{1}{{tan}^{2} α} - υ ) \} \{ 1 - \frac{cosh sy}{cosh sw} \} , \\ where & ( 25 ) \\ s = \sqrt{\frac{2 ( 1 - υ )}{tD} ( \frac{P - D}{P} ) \frac{{sin}^{2} α}{2 - ( 1 + υ ) {sin}^{2} α + ( \frac{t}{d} ) ( \frac{P - D}{P} ) {cos}^{2} α} .} & ( 26 )\end{matrix}$$

### Belt Edge Shear Strain, γ_{xz}

We are now in a position to calculate the inter-ply shear strain in the belts, one of the main objectives of this work. Using Eq 25 in Eq 17 we see that the inter-ply shear strain can be written as

$${γ}_{xz} = - 4 cos α \sqrt{\frac{1}{2 ( 1 - υ )} ( \frac{D}{t} ) ( \frac{P - D}{P} ) \frac{1}{2 - ( 1 + υ ) {sin}^{2} α + ( \frac{t}{d} ) ( \frac{P - D}{P} ) {cos}^{2} α}} \{ \frac{( 1 - {υ}^{2} )}{E} {σ}_{y , BE} + {ɛ}_{x} [ ( \frac{P}{P - D} ) + \frac{1}{2} ( \frac{t}{D} ) ] [ \frac{1}{{tan}^{2} α} - υ ] \} \{ \frac{sinh sy}{cosh sw} \} \qquad ( 27 )$$

where s is given again by Eq 26. This result will be used extensively later, but first the derivation is completed by calculating the longitudinal stress.

### Longitudinal Stress, σₓ

Given the solution for τ_{xy}, the equation set can be solved for the longitudinal stress

$${σ}_{x} = \frac{{σ}_{y , BE}}{{tan}^{2} α} + {ɛ}_{x} \frac{E}{2 ( 1 - {v}^{2} )} [ ( \frac{P}{P - D} ) \frac{2 - ( 1 + v ) {sin}^{2} 2 α}{{sin}^{4} α} + ( \frac{t}{D} ) \frac{1}{{tan}^{2} α} ( \frac{1}{{tan}^{2} α} - v ) ] + {γ}_{xy} \frac{E}{2 ( 1 - {v}^{2} )} [ ( \frac{P}{P - D} ) \frac{sin 2 α [ 1 - ( 1 + v ) {sin}^{2} α ]}{{sin}^{4} α} + ( \frac{t}{D} ) \frac{1}{{tan}^{3} α} ] . \qquad ( 28 )$$

An expression for γ_{xy} to use in Eq 28 can be obtained from Eq. 16 and 25 as

$${γ}_{xy} = \{ ( \frac{P}{P - D} ) \frac{( 1 - {υ}^{2} )}{E} {σ}_{y , BE} + {ɛ}_{x} [ 1 + \frac{1}{2} ( \frac{t}{D} ) ( \frac{P}{P - D} ) ] [ \frac{1}{{tan}^{2} α} - υ ] \} \{ \frac{sin 2 α}{2 - ( 1 + υ ) {sin}^{2} α + ( \frac{t}{D} ) ( \frac{P}{P - D} ) {cos}^{2} α} \} \{ 1 - \frac{cosh sy}{cosh sw} \} . \qquad ( 29 )$$

Then the modulus at the centerline, y=0, of the belt laminate can be written as

$$\frac{{σ}_{x , CL}}{{ɛ}_{x}} = \frac{E}{2 ( 1 - {v}^{2} )} [ ( \frac{P}{P - D} ) \frac{1 - ( 1 + v ) {sin}^{2} 2 α}{{sin}^{4} α} + ( \frac{t}{D} ) \frac{1}{{tan}^{2} α} ( \frac{1}{{tan}^{2} α} - v ) ] , \qquad ( 30 )$$

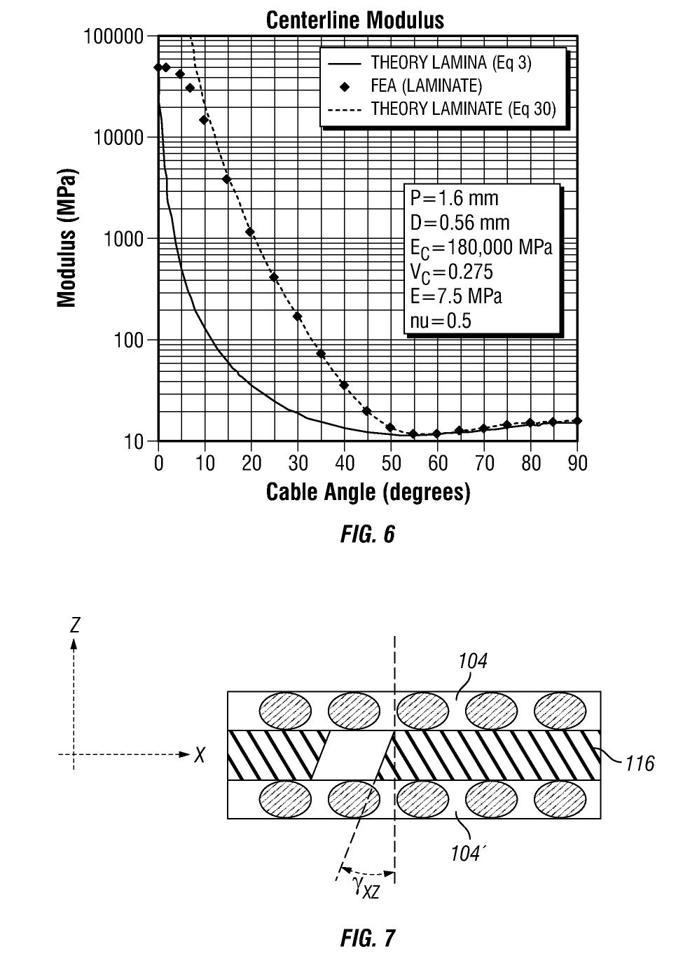

assuming that the imposed belt edge lateral stress is zero. Equation 30 can be used to compare with the centerline belt modulus using FE analysis. FIG. 6 gives the result for the base case of laminate parameters and allowing the belt angle to cover its' full range. Note that above a belt angle of about 15 degrees the agreement with the FE analysis is very good. Below 15 degrees the analytical and FE results separate due to the infinite cable modulus assumption made for the analytical case. The analytical lamina modulus is shown on this figure for comparison. At angles greater than 54.7 degrees (the minimum of the curve) the belts are effectively uncoupled and act essentially as independent lamina. The minimum of the curve represents the belt angle at which there is no Poisson's mismatch between the rubber layer and the lamina.

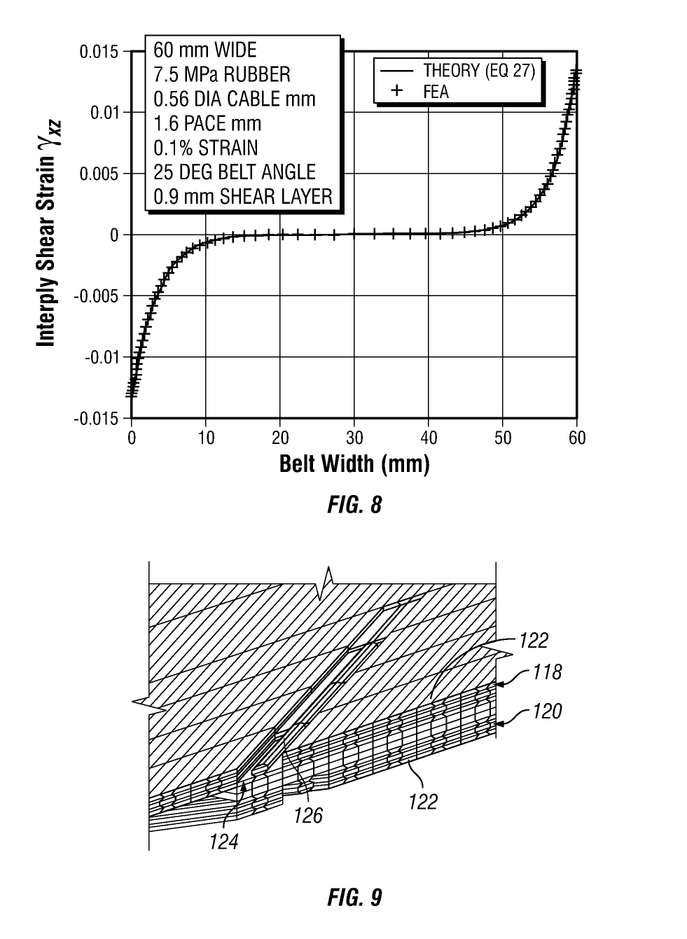

Now we will compare the expression derived for the interply shear strain, Eq. 27, with the FEA analysis. FIG. 7 looks along the Y axis at the edge of the belts 104, 104′ and defines the interply shear strain in terms of angle, γ_{xz}. The base case of the parameters is used for the FEA comparison. FIG. 8 gives the result. The agreement is very good. The FE analysis gives a lower peak value at the belt edge by a few percent as might be expected. Note that the interply shear strain is an edge effect and essentially disappears 10-15 mm inboard of the belt edge. The interply shear strain is effectively independent of the width of the belts thus relatively narrow belt models can be used to study this edge effect. This fact becomes important later in the discrete model discussion. The FE analysis is an axisymmetric Abaqus model using quadratic elements and embedded reinforcements.

Comparison with Published Solution

The classical solution by Puppo and Evensen can be formulated in terms of the nomenclature of this study so that a direct comparison can be made. The classical solution does not include the stiffening mechanism due to the internally generated lateral stress as explained above. Therefore it under predicts the stress and strain values generated by FE analysis and the current analytical solution. The key equations, Eq 25, 26, 28, 27 and 29 are shown below. The terms missing from the classical solution are circled.

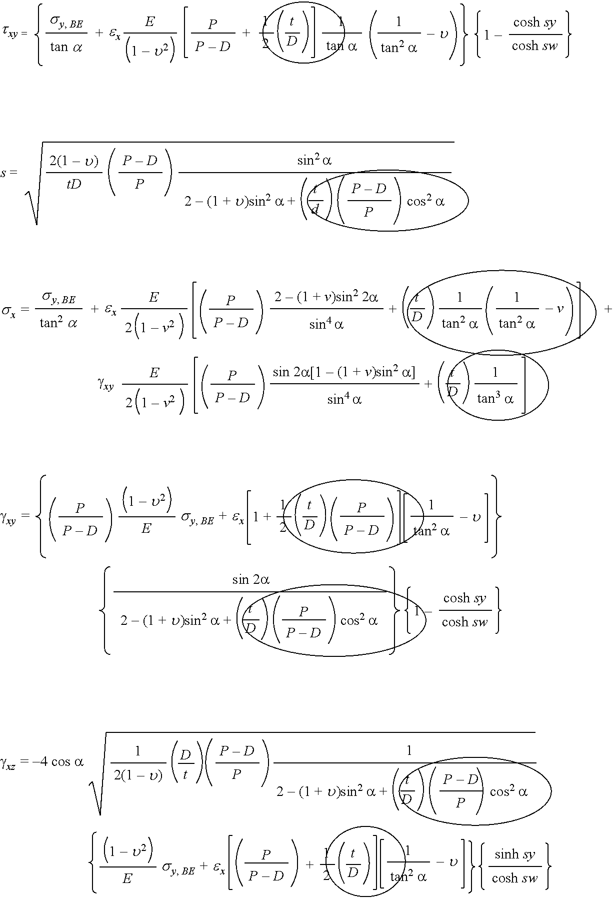

As can be seen, the newly derived analytical model and the associated FEA model are more accurate than prior analytical models for determining interply shear strain.

### Discrete Finite Element Simulation (FEA Model)

### Background

The analytical solution and the FE analysis to this point depend on homogenization of the lamina. An important question is whether the analytical solution or the homogenized FE analysis is indicative of the real stresses that occur in the discrete, cable in rubber, physical belts. To try and answer that question, a FE model will be developed that treats the cables and the rubber matrix as distinct continua.

### Model Description

The model is constructed from three uniquely meshed layers. The upper and lower reinforced layers 118, 120 are meshed with quadratic elements 122 aligned diagonally along the cable directions as shown. The rubber layer 124 separating the reinforced layers is also meshed with quadratic elements 122 but they are aligned with the transverse and longitudinal axes of the complete ply. The geometry of these three layers is arranged such that all of the nodes lying in a plane that adjoins adjacent layers are coincident. FIG. 9 shows a small fragment of the model which highlights this arrangement.

Obviously, such an arrangement introduces a degree of discontinuity into the computed displacement field since element faces of adjoining layers do not share common nodes. However, the overall stiffness of the individual layers is correct and thus the global behavior of the ply is captured. Further, at locations where the nodes coincide, the displacements and resulting strain fields are smooth. Away from these locations the displacements across the layer boundaries are discontinuous. The inventors recognize that this mesh is a less than perfect representation of the structure. However, the results appear to show that for small deformations the arrangement is useful for insight into the mechanics.

### Materials

Definition of material constitutive laws are actually simplified in the discrete model since there is no need to apply volume fraction techniques to the material moduli which describe the reinforced layers. For the rubber, a neo-Hookean law was used where the initial tensile modulus was taken to be 6 MPa. Bulk modulus properties were set such that Poisson's ratio was equal to 0.495.

As shown previously in FIG. 9, the cable bundles 126 have been homogenized into solid elements oriented along the cable direction. A variety of techniques could be applied in the generation of material properties for the cables. In the present case, we have chosen to define the cables as orthotropic with the material 11-direction aligned with the cable axis. This provides a simple framework for adjusting the material properties independently in the various material directions. For the cable orthotropic elasticity matrix, we have set E_{11,22,33}=180,000 MPa, E_{12,13,23}=0 MPa, G_{11,22,33}=1 MPa.

With these properties the bending stiffness of the cable is very low. In fact the cables behave essentially as Timoshenko beams. If Gᵢⱼ is reduced below 1 MPa, the model becomes numerically unstable. On the other hand, if Gᵢⱼ is increased to 100 MPa the cables behave essentially as classical beams (plane sections remain planar and normal to the cable neutral fiber).

### Boundary Conditions

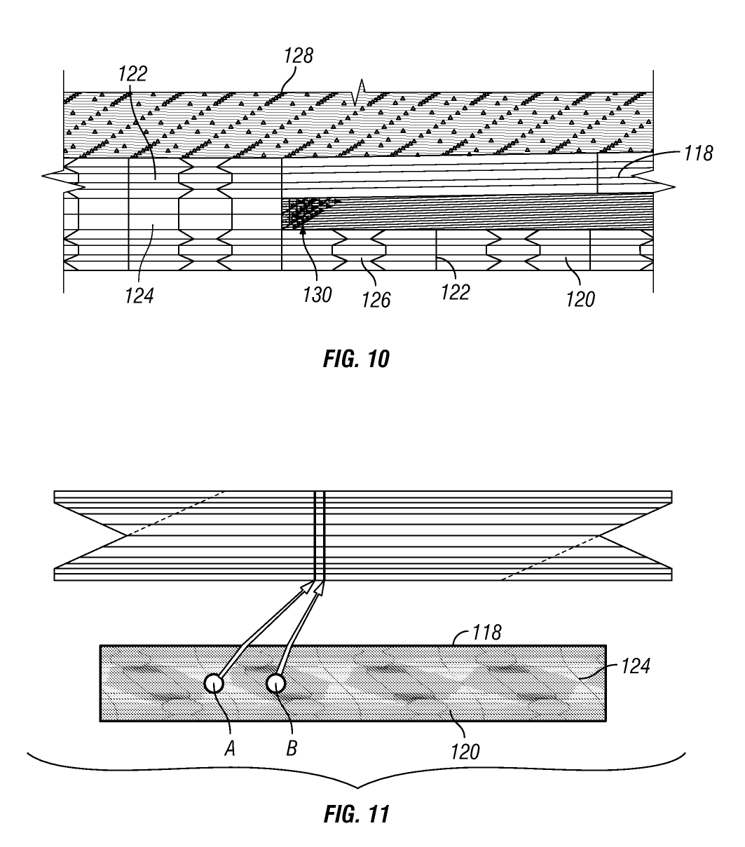

Referring to FIG. 10, the axial strain is introduced into the ply by applying displacements onto the end faces 130 of the rubber layer 124 separating the reinforced layers 118, 120. The tendency of the ply to twist when subjected to the axial load is resisted by requiring the outer face 128 of one of the reinforced layers to remain flat. The length of the model has been established such that the end effects of loading are not seen at the center of the model. The main disadvantage of this set of boundary conditions is that the longitudinal strain at the edges of the ply is less than the longitudinal strains at the centerline. For the models used in this study, the difference is nominally 20%.

Nominal Case Comparison with Homogeneous Theory

Our comparison with the homogenous theory will involve looking at the interply shear strain in the rubber layer 124 connecting the reinforced layers 118, 120. FIG. 11 shows the two locations, A and B, at the midplane of the rubber layer where the interply shear strain will be evaluated as a function of lateral position.

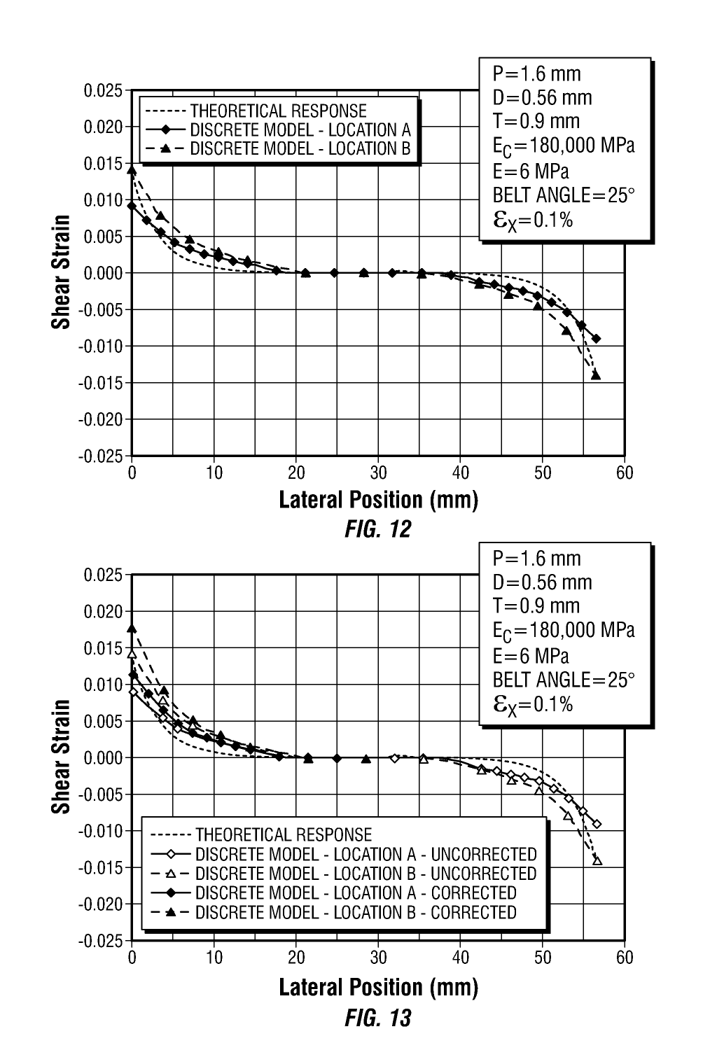

FIG. 12 shows the interply shear strain values for the nominal case where the cable diameter, D, is 0.56 mm, cable pace, P, is 1.6 mm, rubber layer thickness, T, is 0.9 mm and belt angle, α, is 25°. The centerline axial strain is prescribed at 0.1% (edge strain is therefore 0.08%).

Recalling Eq 27, the homogeneous theory indicates that the interply shear strain is a linear function of Eₓ. With this in mind, it seems reasonable to scale the discrete model FE results to account for the reduced values of Eₓ at the ply edges. In FIG. 13 we see the comparison between the theoretical response and the corrected discrete model response.

At this point we can make the following observations regarding the response predicted by the discrete FE model.
1. The mean discrete FE response (strain corrected) appears to agree with the theoretical response at the ply edge.
2. The shear gradient with respect to width is much less in the discrete FE case than the response predicted by theory.
3. The shearing response mentioned in point two allows the shear to persist farther inboard in the ply than does the theoretical response.

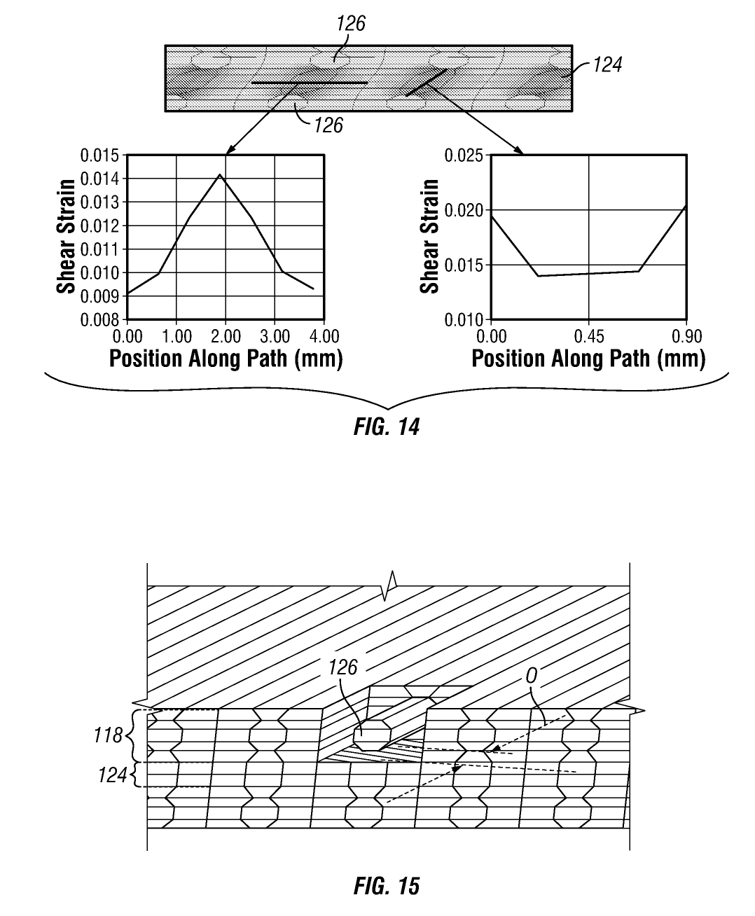

Beyond the response described above, the discrete model also allows us to observe the variation in interplay shear strain between cables. FIG. 14 shows the variation in strain (uncorrected) at the ply edge along the two paths indicated for the nominal case.

Beyond the response described above, the discrete model also allows us to observe the variation in interply shear strain between cables. FIG. 14 shows the variation in strain (uncorrected) at the ply edge along the two paths indicated for the nominal case. As can be seen, the FEA model is well suited to study the strains found between belts that have offset cables within them as it provides similar predictions as trusted analytical models.

### REFERENCES

[1] Puppo, A. H., Evensen, H. E., “Interlaminar Shear in Laminated Composites Under Generalized Plane Stress,” Journal of Composite Materials, Vol. 4, 1970, pp. 204-220.
[2] Turner, J. L., Ford, J. L., “Interply Behavior Exhibited in Compliant Filamentary Composite Laminates,” Rubber Chemistry and Technology, Vol. 55, 1982, pp. 1078-1094.
[3] Kant, T., Swaminathan, K., “Estimation of transverse/interlaminar stresses in laminated composites—a selective review and survey of current developments,” Composite Structures, Vol. 49, 2000, pp. 65-75.
[4] Mittelstedt, C., Becker, W., “Free-Edge Effects in Composite Laminates,” Applied Mechanics Reviews, Vol. 60, Issue 5, 2007, pp. 217-245.
[5] Jones, Robert M., Mechanics of Composite Materials, Hemisphere Publishing Corp., 1975.

### Detailed Description of FEA Study on Belt Package with Belts Having Offset Cables

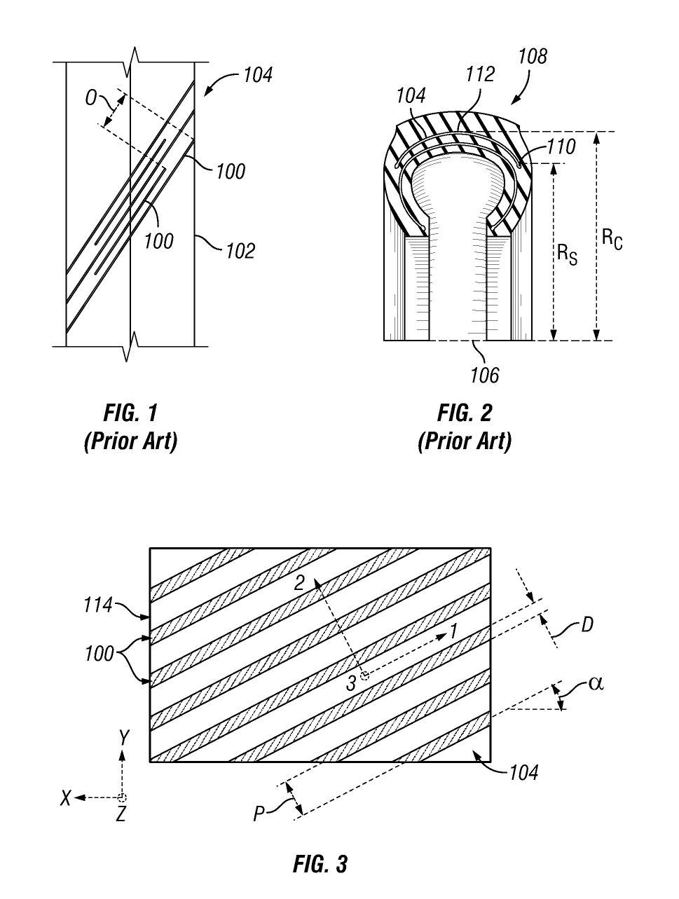

Given the proven accuracy of the FEA model, the inventor preceded to modify the model of the belt package that was discussed in detail above to create belts that have offset cables to see what effect that had on interply shear strain. FIG. 15 shows the FEA model with a portion of the model being removed so that the modeling of a shortened or offset cable 126 can be more clearly seen. In actuality, every other cable of each belt 118, 118′ were shortened similar to what is shown by FIG. 1. The actual offset distance, O, as measured along the length of the cable or the “1” direction was approximately 7 mm but it is contemplated that this offset could range anywhere from 1 mm to 70 mm. Therefore, the pace, P, doubles from 1.1 mm to 2.2 mm in the offset or shoulder regions of the belts, which is represented by area 137 in FIG. 17.

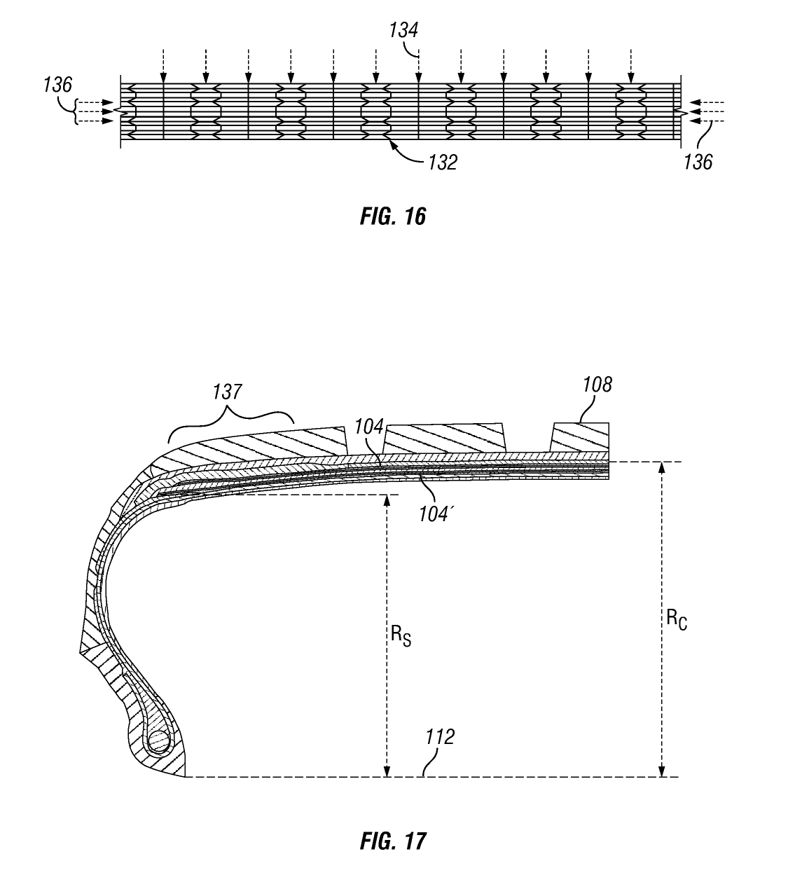

Turning to FIG. 16, the boundary conditions at the end surfaces and bottom surfaces can be clearly seen. A fixed boundary condition 132 was applied on the bottom surface while a modest pressure loading 134 was applied to the top surface to prevent the belts from twisting. At the same time, a slight compressive strain 136 was applied to the end surfaces. It should be noted that the ratio, Rₛ/R_{c}, for this model is fairly flat and is compatible with a full tire model for a 265/75R16 sized tire as illustrated by FIG. 17 where Rₛ/R_{c} is greater than 0.95. This construction mimics the flat tread construction that is typical of most passenger car, light truck and heavy truck tire applications. Therefore, the inventors believe that this model is a good approximation for what would happen if belts with offset cables were used in such tires.

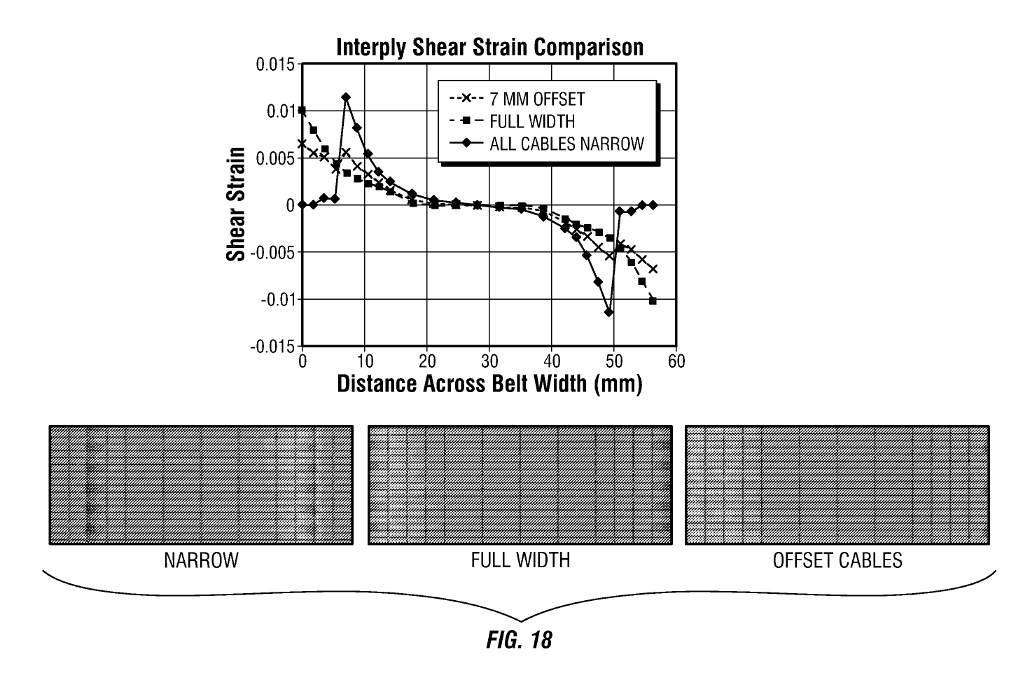

In accordance with the analysis and calculation procedures outlined above, stresses and strains using data collected along two paths, A and B, were calculated. These results were then plotted versus the strains calculated for scenarios where the entire width of the belt is shortened to match the width of the offset cables in the axial direction of the tire and where belts with a full width and no shortened or offset cables were used. The results are shown in FIG. 18.

As can be seen, the strains at the free edge of the belts for the belts with offset cables were 40% lower at about 0.006 than the strain of the full width belts that had no offset cables and 50% lower than the narrowed belts. This predicts that this construction will work effectively to reduce shear strains and the likelihood of belt separation if belts when offset cables are used in an actual tire. These are surprising results in view of the teaching of the prior art that the use of offset cables in belts is not effective for reducing strains at the free edge of belts in tires where the ratio, Rₛ/R_{c}, for the tire is less than 0.95.

### INDUSTRIAL APPLICATIONS USING BELTS HAVING OFFSET CABLES

Given the promising results of the FEA that indicate that tires with flat tread constructions will benefit from the use of belts having offset cables, the inventor applied this concept to typical tire construction to see what actual tire architectures could be achieved using a more modern method of tire construction where the length of cable used in tire belts is fixed.

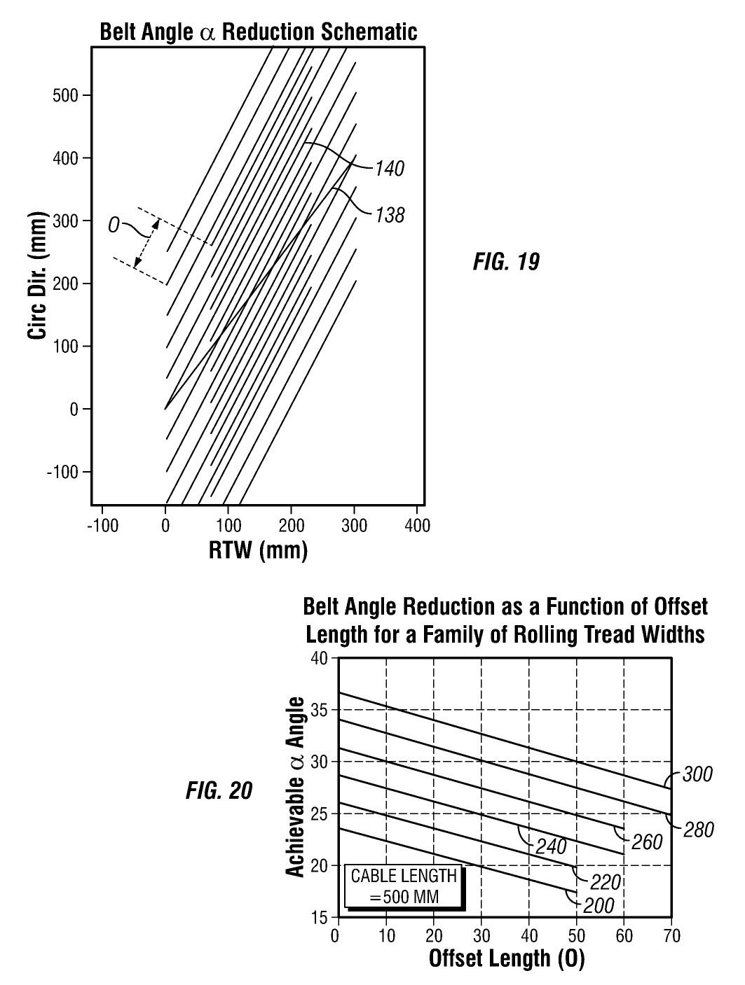

Consequently, the graph shown by FIG. 19 was produced. When using an offset, the belt angle α can be reduced as shown. The lower line 138 spans the original rolling tread width of 300 mm. If an offset length, O, of 70 mm is used, the cable can be rotated to form a narrower belt angle α. This new position of the cable is shown by upper line 140. So a cable of fixed length can be used to effectively form belts of different widths when offsets are used.

FIG. 20 shows what belt angles can be formed for a family of rolling tread widths by simply altering the offset lengths using a cable having a fixed length of 500 mm. As can be seen, this gives the tire designer great flexibility in creating belts having different widths and belt cord angles with a single length of cable. This is particularly useful in more modern tire construction methods that use only a single length of cable. For example, when using a cable having a fixed length of 500 mm on a belt or tire having a rolling tread width of 260 mm, the achievable belt angle ranges from 32 to 24 degrees depending on what offset length is used, which for this case can range from 0 to 60 mm.

While this invention has been described with reference to particular embodiments thereof, it shall be understood that such description is by way of illustration and not by way of limitation. For example, the industrial applications discussed herein involved the use of a pneumatic tire with conventional sidewalls and bead sections. However, it is contemplated that this invention can be used with non-pneumatic tires, hybrid tires and other products as well that have various constructions including those that use web spokes to connect the tire to the wheel of a vehicle. Also, modern tire construction methods that use a single length of cable have been discussed in detail but it is contemplated that offset cables can be used in other tire construction methods including those that create belts by coextruding cables within a rubber skim. Furthermore, while specific examples for cable diameter, rubber layer thickness, pace, belt angle and offset width have been given, it is contemplated that these variables could be altered as desired and are therefore these other possible constructions are within the scope of the present invention. Accordingly, the scope and content of the invention are to be defined only by the terms of the appended claims.

What is claimed is:

1. A tire with a ground contacting portion and having radial, circumferential, axial directions, an axis of rotation and an equatorial plane, said tire comprising a first belt below its ground contacting portion that has first and second free edges along the axial extents of said belt, said belt including at least one cable that has a first end that extends substantially to one of said free edges and a second cable that is offset from said first cable such that the second cable does not extend to said first free edge of said belt, said tire being characterized in that the ratio of Rₛ/R_{c} is greater than 0.95, where Rₛ is the radial distance from said first end of the first cable to the axis of rotation of the tire and R_{c} is the radial distance from the crown or topmost portion of said first cable to the axis of rotation of the tire.

2. The tire of claim 1, wherein said first cable has a second end that extends substantially to the second free edge of said belt and said second cable has a second end that is offset from the second end of the first cable such that the second cable does not extend to either free edge of said belt.

3. The tire of claim 1, wherein said tire further comprises a second belt with free edges at its axial extents and that includes at least one cable that has a first end that extends substantially to one of the free edges of the second belt and a second cable that has a first end that is offset from said first cable of the second belt such that the second cable does not extend to said first free edge of said second belt, said second belt being found radially above the first belt.

4. The tire of claim 2, wherein the distance the first end of the second cable is offset from the first end of the first cable is equal to the distance the second end of the second cable is offset from the second end of the first cable.

5. The tire of claim 1, wherein the width of the first belt is in the range of 150 to 320 millimeters.

6. The tire of claim 1, wherein the first cable and the second cable are parallel to each other.

7. The tire of claim 6, wherein the first and second cable forms angles with the equatorial plane of the tire, which are in the range of 18 to 37 degrees.

8. The tire of claim 1, wherein the distance the first end of the first cable is offset form the second end of the second cable is in the range of 1 to 70 millimeters.

9. The tire of claim 4, wherein the first belt further comprises a third cable that extends substantially to both free edges of the first belt, similar to said first cable, and that is adjacent the second cable of the first belt, said first belt further comprising a fourth cable that is adjacent to the third cable and that has a substantially identical configuration to the second cable of the first belt and is aligned axially with the second cable of the first belt.

10. The tire of claim 1, wherein the pitch from the first cable to the second cable in a direction that is substantially perpendicular to the cables in the offset region of the belt ranges approximately from 1.8 mm to 7.0 mm and ranges from approximately 0.9 mm to 3.5 mm in another region of the belt.

11. The tire of claim 1, wherein the first and second cables are substantially parallel to each other.

12. The tire of claim 1, wherein the diameter of the first cable is substantially the same as the diameter of the second cable and falls within the range of 0.5 to 1.5 millimeters.

13. The tire of claim 1, wherein the length of either the first or second cable is 500 millimeters.

14. The tire of claim 1, wherein said tire is a 265/75R16 sized tire.
